(19) United States
(12) Patent Application Publication
(10) Pub. No.: US 2009/0210403 A1
(43) Pub. Date: Aug. 20, 2009

(54) SYSTEM AND METHOD FOR EXTENDED STRUCTURED SEARCHING ARCHITECTURE

(76) Inventors: Menachem Reinshmidt, Raanana (IL); Erez Keller, Tzur Moshe (IL)

Correspondence Address: DR. D. GRAESER LTD., 9003 FLORIN WAY, UPPER MARLBORO, MD, 20772, US

(21) Appl. No.: 12/371,642

(22) Filed: Feb. 16, 2009

Related U.S. Application Data
(60) Provisional application No. 61/064,156, filed on Feb. 20, 2008.

(51) Int. Cl. G06F 17/30

(52) U.S. Cl. 707/4; 707/3; 707/5; 707/E17.017; 707/E17.109; 707/10

(57) ABSTRACT

A system and method which provides a structured search that can be optimized according to one or more parameters of the user. The one or more parameters may optionally be set before the search or during the search, for example to refine the results, or a combination thereof. According to some embodiments, the method preferably includes a structured search of non-traditional web page documents, including but not limited to repositories of documents, such as those in traditional word processing formats, which are preferably in a repository that is not directly accessed through an HTTP server. According to other embodiments, the method preferably includes searching in a plurality of locations, optionally and preferably using a plurality of different search engines. More preferably the plurality of locations includes but is not limited to locations that are local to the user, locations available through a computer network such as the Internet and/or an intranet for example, and/or document repositories. According to still other embodiments, there is provided a system and a method for structured searches which focus and fine tune the search process for the user. Preferably, the system and method assist the user to focus and/or fine tune the search, for example through adjusting one or more search parameters.

This Application claims priority from U.S. Provisional Application No. 61/064,156, filed on Feb. 20 2008 and hereby incorporated by reference as if fully incorporated herein.

### FIELD OF THE INVENTION

The present invention relates to a system and a method for an extended structured searching architecture, and in particular, to such a system and method which enable an optimized search to be performed according to one or more optimization parameters.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. However, the explosion of information has made it more difficult for users to find the information of interest.

Various generic search engines are available which attempt to provide such information to users. For example, Google®, Yahoo® and Live® (Microsoft) are all examples of search engines which can be used by any user to search any topic. However, their generic nature also renders them non-specific; frequently users cannot find the information of interest simply because there are too many results.

Currently all of the efforts for searching technology and the emphasis on search performance are made on the server side, rather than providing assistance or analysis through the client side. Instead only a conventional web browser is used for searching. However, this can be disadvantageous because a simple web browser may not be sufficient for efficient searches. Furthermore, the simple web browser cannot be easily customized for the needs and preferences of the user, while generic search engines are only capable of offering a limited range of options.

Prior art attempts to provide advance searching include PCT Application WO 2003/038678: WEB-BASED SEARCH SYSTEM. However, again the emphasis is on the use of a web browser as a generic client for such searches. The currently available search engines, including Google®, Yahoo® and Live® for example, all use a web browser as a generic client.

Despite these problems, many users have a favorite search engine as they are comfortable with the interface and they feel that the particular search engine gives the best results. However for a specific search, it may be that the optimal results would have been available through a different search engine. So-called “combined” search engines which obtain and re-rank multiple results from many search engines are also not necessarily useful, as they may simply amplify problems from each individual search engine. However, it is difficult for users to compare multiple search results from multiple search engines quickly and easily.

Furthermore, the actual ranking mechanisms used may also cause problems, as the user may be forced to examine the search results extensively and/or repeat the search with different terms repeatedly, because the desired result is found deep within the returned web pages with the search results. This requires more time for the search and may cause the user to stop searching before the desired search result is located.

### SUMMARY OF THE INVENTION

There is an unmet need for, and it would be highly useful to have, a system and a method for structured searches which can be optimized. There is also an unmet need for, and it would be highly useful to have, a system and a method for structured searches of non-traditional web page materials, such as documents for example. There is also an unmet need for, and it would be highly useful to have, a system and a method for structured searches in a plurality of different locations, whether local to the user, for example in the user's computer, and/or in a local area network (LAN) and/or in the enterprise network, and/or through an external network such as the Internet and/or of document repositories. There is also an unmet need for, and it would be highly useful to have, a system and a method for structured searches which focus, expedite and fine tune the search process for the user.

The present invention overcomes these drawbacks of the background art by providing a system and method which provides a structured search that can be optimized according to one or more parameters of the user. The one or more parameters may optionally be set before the search or during the search, for example to refine the results, or a combination thereof.

According to some embodiments, the method preferably includes a structured search of non-traditional web page documents, including but not limited to repositories of documents, such as those in traditional word processing formats, which are preferably in a repository that is not directly accessed through an HTTP server. However, the documents in the repository may optionally include mark-language documents although not served through an HTTP server. The structure and location of the storage for the repository preferably are local to a computer of a user, such that the content of the file is not important. For example the content may also optionally include but is not limited to one or more of audio, video, still images, executable files, as well as any type of document format.

According to other embodiments, the method preferably includes searching in a plurality of locations, optionally and preferably using a plurality of different search engines. More preferably the plurality of locations includes but is not limited to locations that are local to the user, locations available through a computer network such as the Internet and/or an intranet for example, and/or document repositories.

According to still other embodiments, there is provided a system and a method for structured searches which focus and fine tune the search process for the user. Preferably, the system and method assist the user to focus, expedite, lo and/or fine tune the search, for example through adjusting one or more search parameters.

By “online”, it is meant that communication is performed through an electronic communication medium, including but not limited to, telephone voice communication through the PSTN (public switched telephone network), cellular telephones, IP network, or a combination thereof; data communication through cellular telephones or other wireless devices; any type of mobile or static wireless communication; exchanging information through Web pages according to HTTP (HyperText Transfer Protocol) or any other protocol for communication with and through mark-up language documents or any other communication protocol, including but not limited to IP, TCP/IP and the like; exchanging messages through e-mail (electronic mail), messaging services such as ICQ™ for example, and any other type of messaging service or message exchange service; any type of communication using a computer as defined below; as well as any other type of communication which incorporates an electronic medium for transmission.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and memory storage, and/or the ability to execute one or more instructions may be described as a computer, including but not limited to a PC (personal computer), a server, a minicomputer, a cellular telephone, a smart phone, a PDA (personal data assistant), a pager, TV decoder, VOD (video on demand) recorder, game console, digital music or other digital media player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary system according to the present invention;

FIG. 2A shows a schematic block diagram of search engine client 104 in an exemplary, illustrative system 200;

FIG. 2B shows an exemplary, illustrative schematic block diagram of a user interface as provided by the Gogimon browser (not shown) with a plurality of search results from different search engines;

FIG. 3A shows a flowchart of an exemplary method according to the present invention for an adaptive context search;

FIG. 3B shows a non-limiting, exemplary example of a display from FIG. 3A;

FIG. 4 shows a flowchart of an exemplary method according to the present invention for a layered search;

FIG. 5A shows an exemplary, illustrative method for a plurality of search engines to receive a search query for performing a search through a network;

FIG. 5B shows exemplary results of the method of FIG. 5A;

FIG. 6 shows a flowchart of an exemplary, illustrative method for performing a search through a local computer through which the search is entered;

FIGS. 7A and 7B relate to a method and a system for searching through repositories of documents;

FIG. 8 shows a flowchart of an exemplary, illustrative method for entering information for a search by a user;

FIG. 9A shows a flowchart of an exemplary, illustrative method for parsing search results once they have been received after a search request;

FIG. 9B shows three exemplary, non-limiting web page containers, with checkboxes at the left hand side for user selection;

FIG. 10A shows a flowchart of an exemplary, illustrative method according to the present invention for ranking results of a search;

FIG. 10B shows an exemplary Gogimon browser interface with the ranked, merged list of results shown under the heading “GOGIMON Ranking”;

FIG. 11 shows a flowchart of an exemplary, illustrative method according to the present invention for constructing RSS feeds from search results;

FIG. 12 shows an exemplary, illustrative method for a background web communication channel;

FIG. 13 shows an exemplary, illustrative collaborative search process and system;

FIG. 14 shows a flowchart of an exemplary, illustrative method according to the present invention for performing a guided search;

FIG. 15A shows a flowchart of an exemplary, illustrative method according to the present invention for selective parallel download of search results;

FIG. 15B shows an exemplary user interface display featuring such checked results being displayed;

FIG. 16 shows a schematic block diagram of an exemplary, illustrative system according to the present invention for focusing a search of the user, preferably once the user has received at least initial search results;

FIG. 17 shows a flowchart of an exemplary, illustrative method according to the present invention for performing a continuous search;

FIG. 18 shows a flowchart of an exemplary, illustrative method according to the present invention for performing RSS (or other syndication protocol) fine tuning of search results;

FIG. 19 shows a flowchart of an exemplary, illustrative method according to the present invention for performing fine tuning with metatags;

FIG. 20 shows a flowchart of an exemplary, illustrative method according to the present invention for performing fine tuning with favorites;

FIG. 21 shows a flowchart of an exemplary, illustrative method according to the present invention for performing fine tuning with previously viewed or displayed web pages and/or other results;

FIG. 22 shows an exemplary, illustrative method for fine tuning search results according to user selection;

FIG. 23 shows an exemplary, illustrative method for fine tuning search results according to one or more previous user interactions;

FIG. 24 shows an exemplary, illustrative method for fine tuning search results according to one or more checked previous user results; and

FIG. 25 shows an exemplary, illustrative method for fine tuning search results in a pre-search process.

### DESCRIPTION OF THE PREFERRED EMBODIMENTS

The principles and operation of the present invention may be better understood with reference to the drawings and the accompanying description.

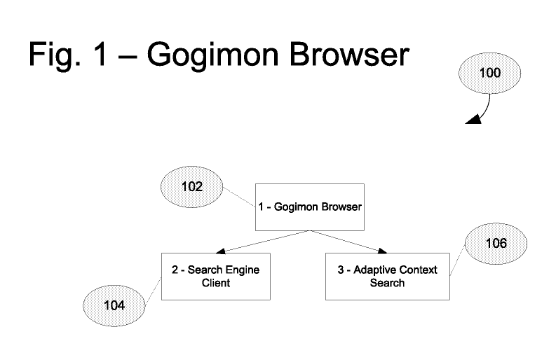

Referring now to the drawings, FIG. 1 is a schematic block diagram of an exemplary, illustrative system according to the present invention. As shown, a system 100 preferably features a Gogimon browser 102 which provides an interface for a plurality of different types of searches through a computer network such as the Internet, intranet and/or any type of LAN (local area network), WAN (wide area network) and the like (not shown). Gogimon browser 102 may optionally be implemented as any type of software user interface, including but not limited to a GUI (graphical user interface), text based interface, audio based interface and so forth. Gogimon browser 102 preferably enables any type of mark-up language document to be displayed, such as web pages for example and more preferably also supports other types of documents, such as word processing document formats, document formats such as the pdf format of Adobe Inc (as an example of a document sharing format) and the like, for example. Gogimon browser 102 may optionally function as for any other type of web browser in terms of displaying web pages.

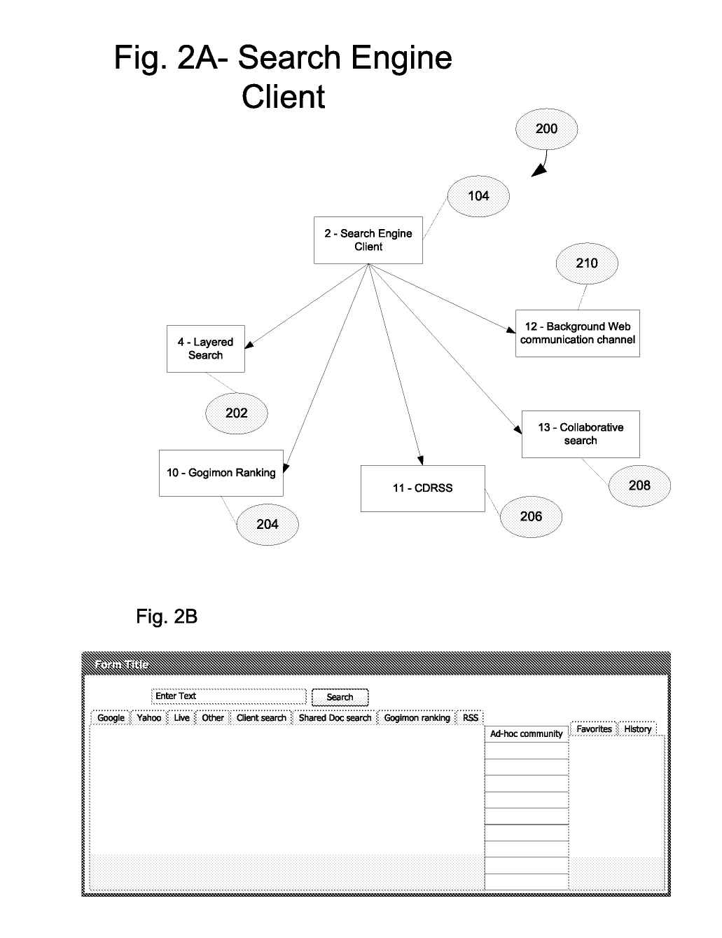

Gogimon browser 102 preferably features a search engine client 104, shown in FIG. 2A in more detail, for communicating with one or more external search engines (not shown). Search engine client 104 is preferably able to communicate with an external search engine for performing a search, and more preferably is able to cause the results to be displayed to the user (not shown). Optionally and most preferably, search engine client 104 supports adjusting, analyzing, refining, optimizing and/or parsing one or more search results according to one or more fine tuning parameters for the user, as described in greater detail below. Such parameters preferably assist the user to obtain an expedited and more efficient search process. Also optionally and most preferably, search engine client 104 supports performance of at least one additional search within the search results and/or through the search engine according to the one or more fine tuning parameters for the user.

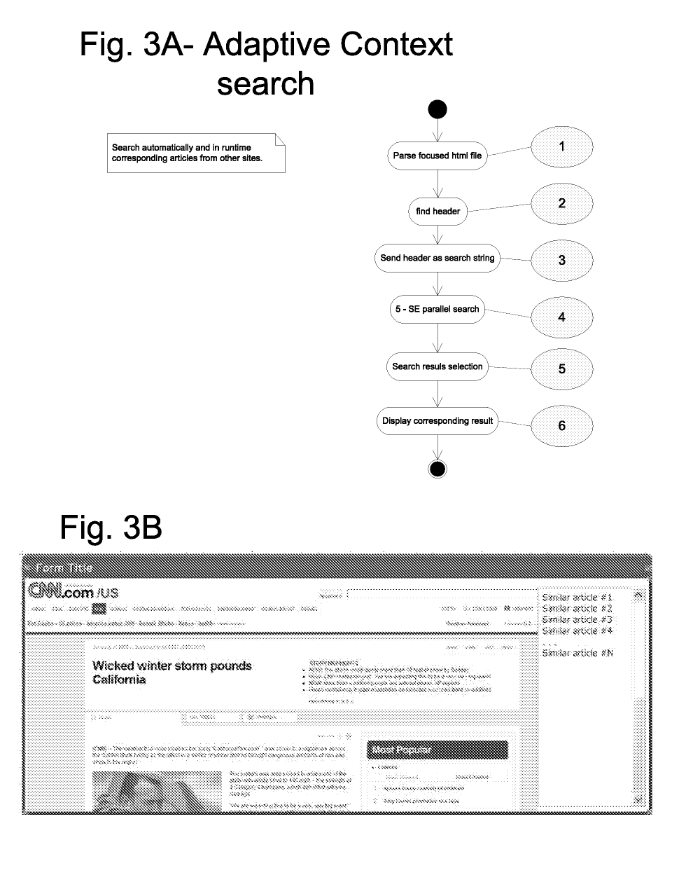

Gogimon browser 102 preferably also features an adaptive context search 106, for providing one or more automatic background search results to the user (see FIG. 3A). The one or more search results are optionally and preferably provided as a side bar and/or other type of display outside of, and/or immediately adjacent to, a web page being viewed by the user; the web page being viewed provides a trigger for the search. These search results preferably include one or more additional web pages which are similar to the web page being viewed by the user. Optionally, if searches may also be performed on local files and/or file repositories, similar documents and/or files may also be searched (in addition to or in place of web pages). The similarity is preferably determined according to commonality between the page being viewed and one or more other pages, optionally according to one or more of ranking by a search engine and ranking according to one or more user parameters as described above. Optionally and preferably information is obtained from analysis of the web page being viewed and is used for performing the search. The user may then choose to view the one or more additional web pages by clicking on or otherwise selecting the web page and/or a link to the web page. The search may optionally be a local search (involving one or more resources local to the user) and/or a shared search; furthermore, the search may optionally be of any type of document, including but not limited to mark-up language documents such as web pages, word processing documents, audio files, video files, image files, multimedia files and the like.

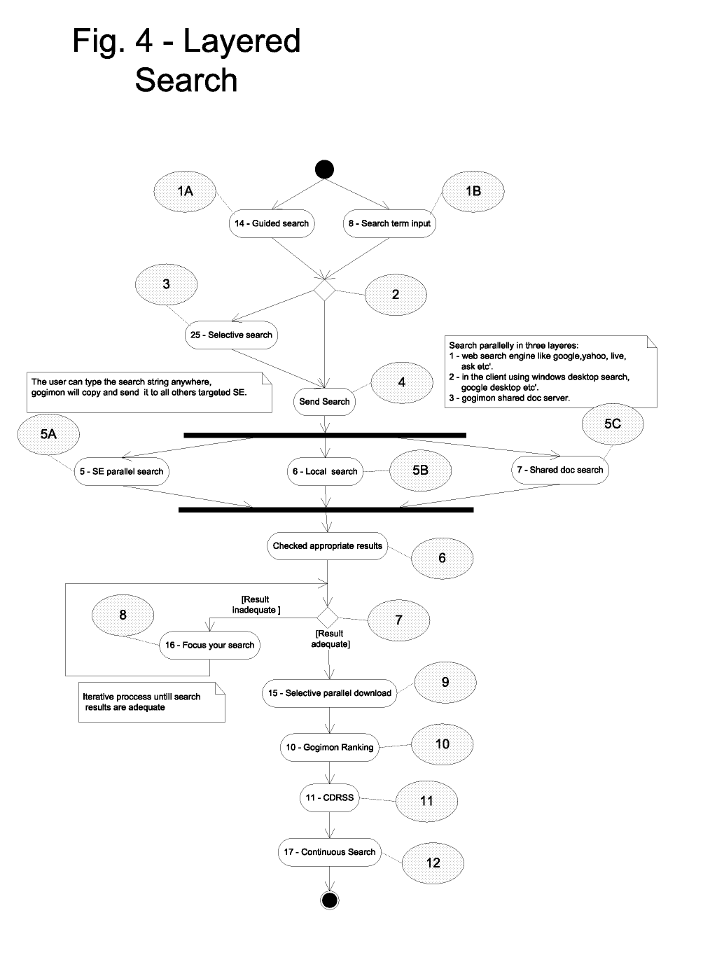

FIG. 2A shows a schematic block diagram of search engine client 104 in an exemplary, illustrative system 200. Search engine client 104 preferably communicates with a layered search 202 for providing the user with an adjusted user search experience according to one or more user inputs (see FIG. 4 for more details). Such adjustments optionally include but are not limited to parsing the search results for refining the search, providing the search results in an organized and easily comparable manner through the user interface, assisting the user to select and/or adjust search terms to obtain the best results, personalization, fine tuning, comparing search results between a plurality of search engines and the like, and are described in greater detail below.

Search engine client 104 preferably also communicates with a Gogimon ranking 204, in which the results from searches with at least one and more preferably a plurality of search engines are ranked. The ranking preferably results in a re-ranking of such search results. For example, the search results may optionally be re-ranked according to one or more user parameters, such as web sites found in a “favorites” or “history” storage of the web browser, one or more user preferences for such sites, processing the received rankings from a plurality of different search engines and the like, as described in greater detail below.

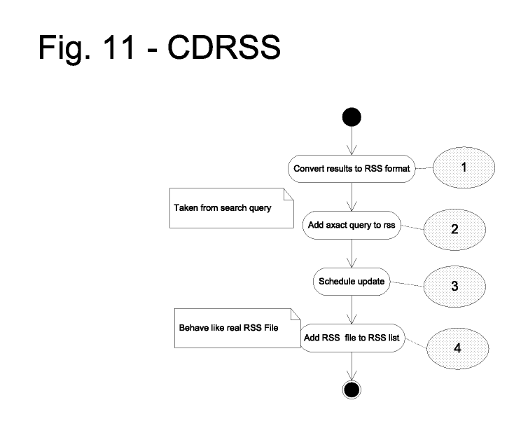

A CDRSS 206 is preferably in communication with search engine client 104, for supporting searches of RSS (Really Simple Syndication or RDF Site Summary) feeds, more preferably for continuous searches (described in greater detail below; see FIG. 11). Optionally CDRSS 206 also converts search results to the RSS format, for example for being stored as RSS feeds. RSS is the name for a family of different Internet formats for providing updates regarding web sites. An RSS document, also referred to as a “feed”, provides the updated information in a format which may be accessed by an RSS reader. As used herein, the term “RSS” is preferably used to represent any non mark-up language format for syndication and/or distribution of documents and communication through the Internet. Another non-limiting example of such a syndication protocol is ATOM (Atom Syndication Format). CDRSS 206 supports searches through such RSS documents or feeds, by providing the RSS information in a suitable structure for search engine client 104. For example, CDRSS 206 may optionally save ranking of search results, save in the RSS or other syndication protocol format, thereby enable the search to be performed at least a plurality of times and optionally continuously. CDRSS 206 may optionally then update the ranking (for example for an autonomous search).

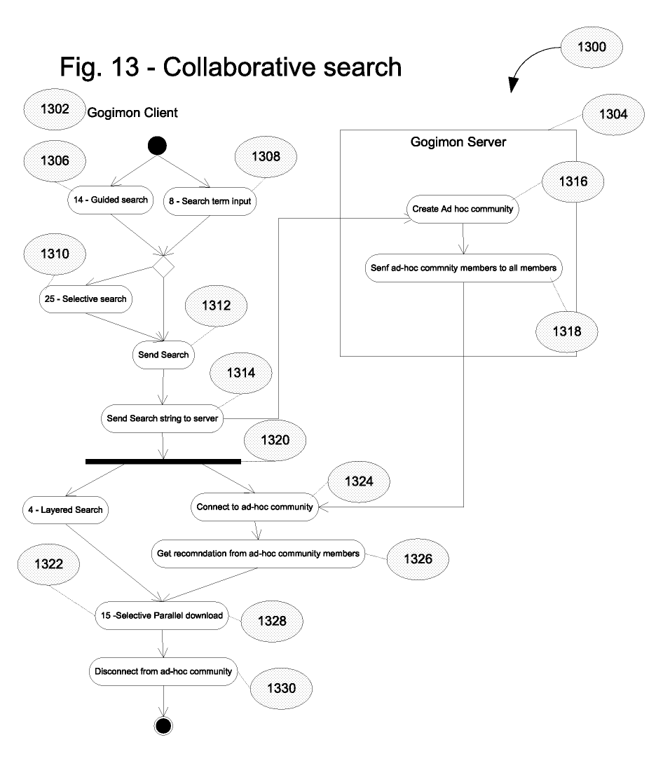

A collaborative search 208 is also preferably provided as part of system 200, for enabling a community of users to interact for sharing information about various topics, which is an optionally an ad hoc community (see FIG. 13). Collaborative search 208 preferably supports an, optionally ad hoc, social network of users who are interested about a particular topic or category of information and who wish to communicate, optionally in real time, regarding sources of information related to their topic or category of interest. Optionally, such an ad hoc social network of users may provide opinions and/or reviews concerning the value of one or more sources of information regarding the topic or category of interest.

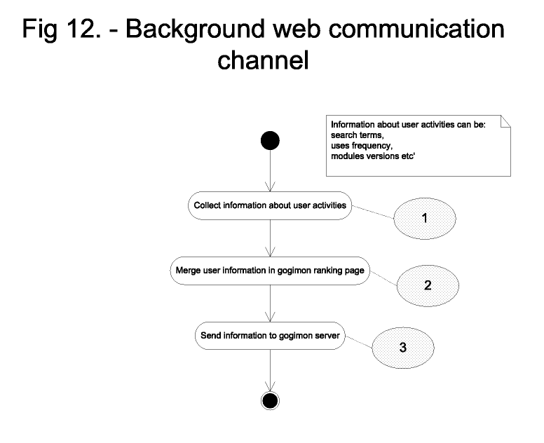

In order to better assist Gogimon ranking 204 and optionally other functions in an external server associated with the Gogimon browser (not shown), a background web information channel 210 is preferably provided (see FIG. 12). Background web information channel 210 is preferably accessed as for any other web page, according to HTTP or other mark-up language format for communication, to avoid problems which are associated with malicious software and/or other potential security vulnerabilities and the like. Background web information channel 210 is optionally and preferably installed, more preferably with user permission, as part of Gogimon browser 102 (not shown). Background web information channel 210 gathers information, preferably anonymized, about user searches and preferences, in order to provide additional information, for example, for rankings provided by Gogimon ranking 204. Background web information channel 210 may optionally be bi-directional, for example for sending updated software, advertisements and the like.

FIG. 2B shows an exemplary, illustrative schematic block diagram of a user interface as provided by the Gogimon browser (not shown) with a plurality of search results from different search engines. More preferably, the results from each search engine are shown in a separate tab, to allow the user to view each set of results separately. The results in each tab preferably show the entire web page as returned by the search engine, more preferably to preserve the “look and feel” of these web pages, optionally including advertisements and the like, such that the Gogimon browser functions as a container for the web pages, rather than completely redoing them. A tab for “Gogimon ranking” preferably shows the re-ranked as described above. An “ad-hoc community” tab preferably relates to search communities as described above.

FIG. 3A shows a flowchart of an exemplary method according to the present invention for an adaptive context search, which as previously described preferably relates to a background type of search. The method is performed when the user is viewing a web page as displayed in the Gogimon browser. The example is described with regard to web pages but may optionally include any type of file. In stage 1, the web page being viewed by the user, such as any type of mark-up language document, including but not limited to HTML, XML, XSL and the like, is parsed. Other types of documents such as word processing documents, pdf, text, images (preferably after OCR) and the like may also optionally be parsed, additionally or alternatively. In stage 2, one or more fields within the document are located, such as the header, sub-headers, meta-tags and the like and/or the content of the document is analyzed to locate the main or characterizing keywords for example. In stage 3, the content or keywords of the one or more fields is preferably sent as a search term to one or more search engines. The content of the one or more fields may optionally be parsed before being sent for searching, for example to reduce the number of terms and/or to provide focus with regard to the most important terms and/or relationships between the terms.

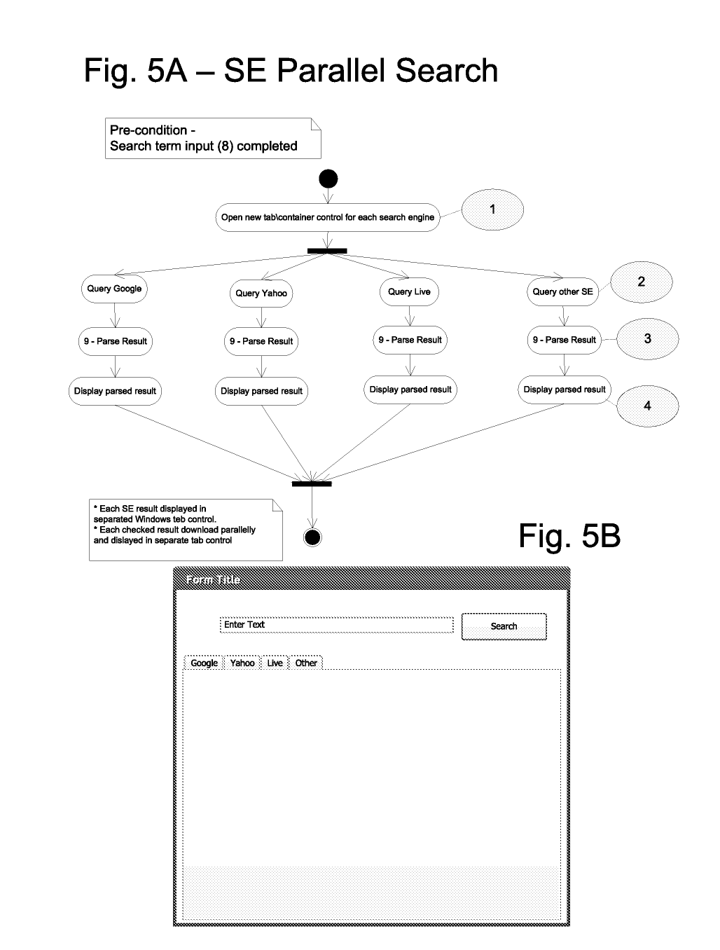

In stage 4, a search is performed, preferably through a plurality of search engines as described in more detail with regard to FIG. 5. In stage 5, the results are optionally and preferably selected according to one or more criteria such as ranking from the individual search engines. In stage 6, one or more selected results of the search are displayed, preferably in a location which does not completely overlay the current web page being viewed by the user yet which still enables the user to view these results.

A non-limiting, exemplary example of such a display is shown in FIG. 3B, in which a web page is shown as displayed to the user. On the right-hand side, one or more links to other web pages showing similar information are provided, without completely overlaying the initial web page being displayed.

FIG. 4 shows a flowchart of an exemplary method according to the present invention for a layered search. As shown, in stage 1A the user selects a guided search or in stage 1B, the user selects a regular or non-guided search. These different types of search input processes affect the user experience but not the search itself; they are discussed in greater detail below.

In stage 2, the user optionally selects whether to perform a selective search or to continue without such a selective search. For the former, the process continues to stage 3; otherwise the process skips stage 3 and continues to stage 4.

If selected, in stage 3 a selective search is performed, in which one or more search parameters are adjusted according to one or more user parameters. Such user parameters may optionally include previous web pages visited, searches performed, “favorite” web pages and/or RSS sources in which the location (URL or other address) of the web page is stored and so forth, as described in greater detail below.

In stage 4, the search parameters (adjusted or otherwise) are preferably sent to at least one and more preferably a plurality of search engines. The search engines may optionally be adapted for searching the Internet and/or other types of computer networks for documents, as shown in stage 5A. The search engines may optionally be adapted for searching through the local computer through which the search request was entered, as shown in stage 5B. The search engines may also optionally be adapted for searching through repositories of documents, as shown in stage 5C (described in greater detail below).

The results are preferably displayed to the user in stage 6, who may optionally select one or more specific results, such as specific URLs and/or file locations or other addresses for example. In stage 7, the user determines whether the search results are acceptable. If not, in stage 8, the user is preferably assisted to focus and/or otherwise alter the search term(s), after which the search is optionally and preferably performed again, as described later in details. The process then preferably returns to stage 6.

In stage 9, the results are determined to be acceptable, after which a plurality of search results are preferably displayed. For example, the search results may optionally include a plurality of web pages, which are optionally and preferably downloaded in parallel, as selected by the user in stage 6. In stage 10, the results are optionally re-ranked according to Gogimon ranking as previously described.

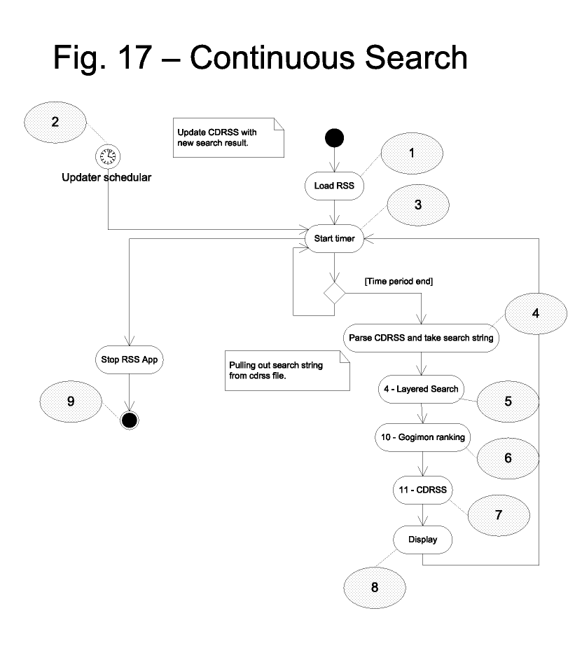

In stage 11, optionally a CDRSS is performed as previously described. In stage 12, optionally a continuous search is performed, for example with the results of the CDRSS, such that each time updated information is available, it is preferably provided to the user (see FIG. 17 for more details).

As previously described, a plurality of search engines may optionally receive a search query for performing a search through a network, an exemplary, illustrative method for which is shown in a flowchart in FIG. 5A. The search term(s) are preferably input, after which a new display tab control or other container is preferably initiated for each search engine as shown in stage 1. In stage 2, a plurality of search engines preferably receive the search term(s), more preferably through a web page transmission through a protocol such as HTTP for example as for a regular search engine search. Alternatively, the search string query may optionally be constructed independently and then directly input to the search engine servers according to a protocol such as HTTP for example as is known in the art. Optionally the search may be sequential but is preferably parallel.

In stage 3, the results from each search engine are preferably parsed, as described in greater detail below. In stage 4, the parsed results are preferably displayed, more preferably in each tab control or other container as shown in FIG. 5B.

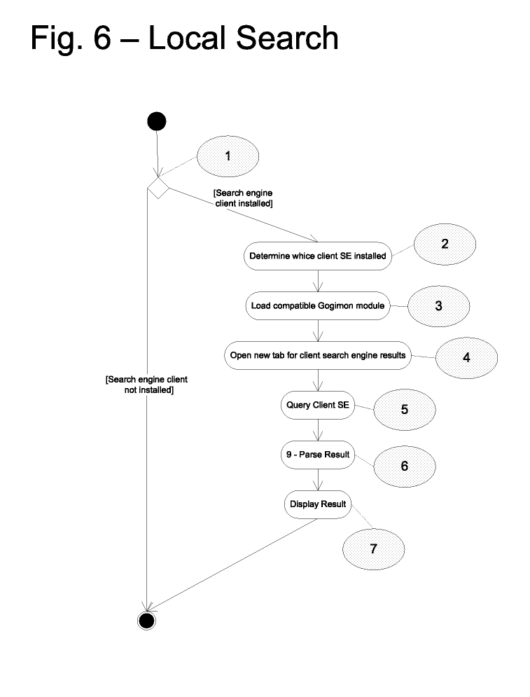

FIG. 6 shows a flowchart of an exemplary, illustrative method for performing a search through a local computer through which the search is entered. By “local computer” it is meant one or more computers, accessible to the user and containing documents or other information of the user. The term “computer” may optionally include any type of computer as defined above, including without limitation cellular telephones or other mobile communication devices. In stage 1, the user requests a local search. The method may only continue if a suitable local search engine is available, such as the desktop tool of Google Inc for example. Otherwise, the user is preferably instructed to download or otherwise install such a suitable local search engine.

In stage 2, the type of local search engine is detected, whether automatically or manually (optionally by having the user enter the name for the latter). In stage 3, a compatible Gogimon wrapper module is loaded, which can interact with the particular local search engine.

In stage 4, if the Gogimon browser is used to display the results, preferably a separate tab control or other container, or other type of display, is provided for displaying the results. In stage 5, the local search engine receives the search term(s) for searching. In stage 6, the results are preferably parsed. In stage 7, the results are displayed.

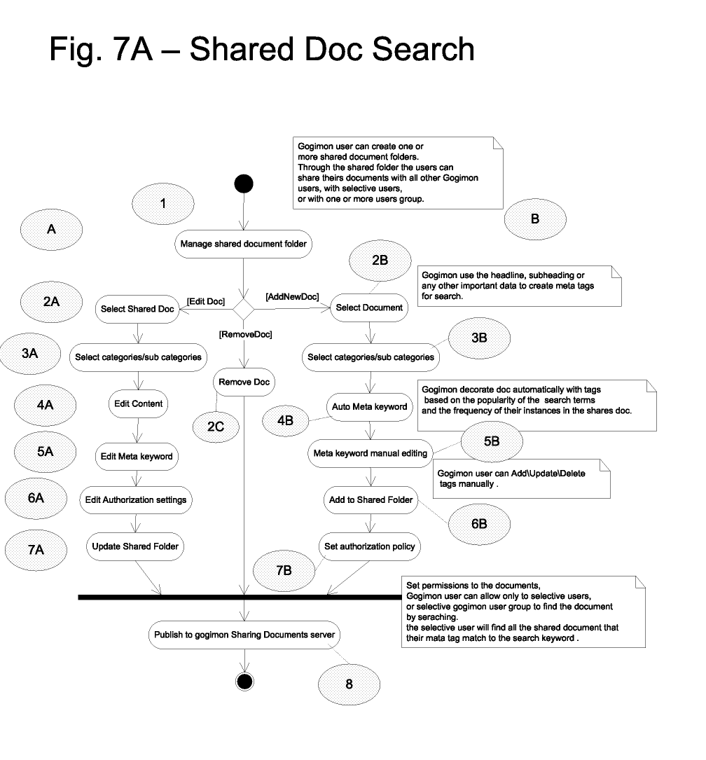

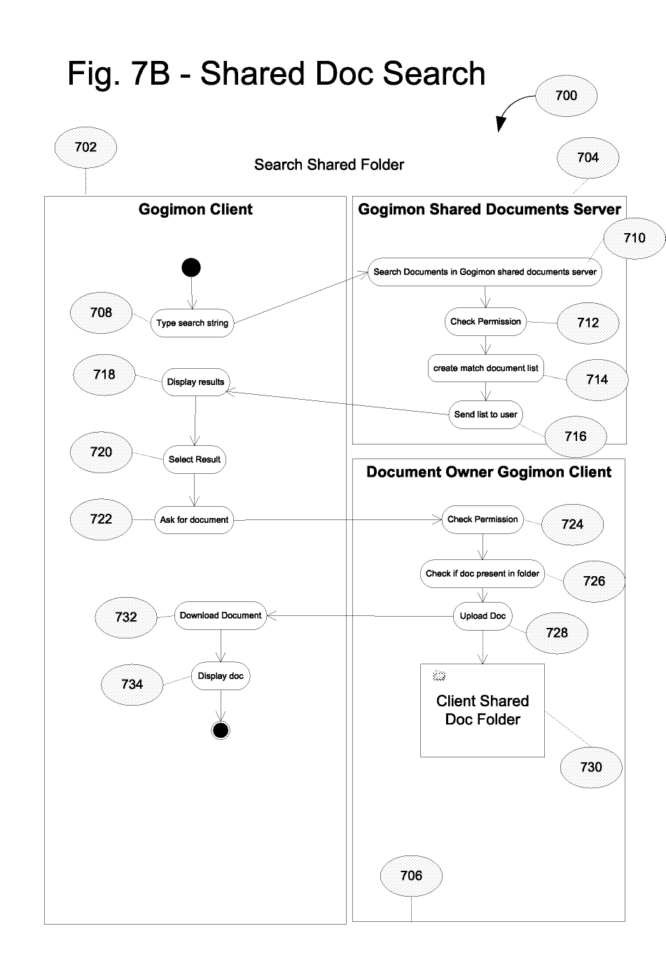

FIGS. 7A and 7B relate to a method and a system for searching through repositories of documents. As shown, the documents may optionally include any such format, including but not limited to, mark-up language documents, word processing documents (including without limitation the Word software format of Microsoft Corp, the pdf document format of Adobe Acrobat and so forth), images, music and so forth. Preferably the searched repository is not directly accessed through an HTTP server. However, the documents in the repository may optionally include mark-language documents although not served through an HTTP server. The structure and location of the storage for the repository preferably are local to a computer of a user, such that the content of the file is not important. For example the content may also optionally include but is not limited to one or more of audio, video, still images, executable files, as well as any type of document format.

FIG. 7A shows a flowchart of an exemplary method according to the present invention for managing a shared document folder, which may then optionally be searched. In stage 1, a shared document folder is created with one or more documents to be shared. By “document” it is optionally meant any type of file. The branch for subsequent stages labeled “A” relates to editing one or more aspects of documents stored in the shared document folder, while the branch for subsequent stages labeled “B” relates to adding a new document to the shared document folder.

Turning first to the “A” branch, in stage 2A a shared document is selected from the folder. In stage 3A, one or more categories or sub-categories into which the document is placed are optionally edited. In stage 4A, the content is optionally edited. In stage 5A, one or more meta-tags or other associated keywords or characterizing terms are optionally edited. In stage 6A, one or more authorization and access settings are optionally edited. It should be noted that optionally only one or a plurality of stages 3A-6A are performed and that the order in which a plurality of stages is performed is not restricted to the order shown.

In stage 7A, the shared folder is updated with one or more of the above changes to the shared document.

Turning now to the “B” branch, in stage 2B a document to be added to the shared documents folder is selected. In stage 3B, one or more categories or sub-categories into which the document is placed are edited. In stage 4B, one or more meta-tags or other associated keywords or characterizing terms are preferably added automatically according to the content of the document. For example, according to words or phrases which have a frequent appearance and/or which are graphically emphasized, for example with bold face font, font size and the like. In stage 5B, the one or more meta-tags or other associated keywords or characterizing terms are preferably edited and/or added manually by the user, or at least approved by the user. In stage 6B, the new document is added to the shared document folder. In stage 7B, the authorization and access settings are preferably set by the user, in order to determine the permission right(s) for accessing the shared document.

An optional stage 2C involves removing the document from the shared documents folder.

In stage 8, the change(s) are preferably published or otherwise provided to the shared documents server, described with regard to FIG. 7B.

FIG. 7B shows an exemplary, illustrative system according to the present invention for searching through shared document folders. A system 700 preferably features a Gogimon client 702, a Gogimon shared documents server 704 and a document owner Gogimon client 706. The user of Gogimon client 702 enters a search string 708 for a shared document search. The search string is preferably sent to a search module 710 in Gogimon shared documents server 704 for searching through the shared documents. If one or more results are found, then preferably permission(s) are determined 712; document(s) for which the requesting user (from Gogimon client 702) has permission to view or otherwise access are then preferably included in a document list 714. Document list 714 is preferably then returned 716 to Gogimon client 702.

The results are displayed 718 through Gogimon client 702 to the user. If the user finds one or more results to be suitable, they are preferably selected 720. A document request 722 is preferably then sent to document owner Gogimon client 706, which again preferably determines whether permission may be granted 724 to access the one or more documents. If permission may be granted, then each document is preferably examined to see whether it is present 726 in the folder 730. If so, the document is preferably uploaded 728 from document owner Gogimon client 706, more preferably according to a peer-to-peer communication protocol, and then downloaded 732 by Gogimon client 702. The document is then preferably displayed 734.

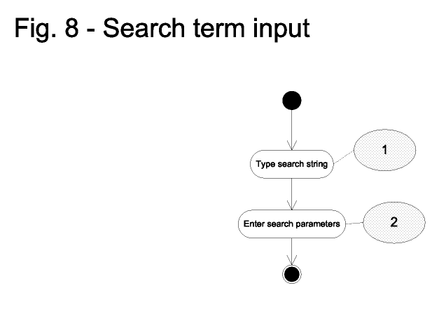

FIG. 8 shows a flowchart of an exemplary, illustrative method for entering information for a search by a user. In stage 1, the user types or otherwise enters one or more search terms, such as a search string for example. In stage 2, the user preferably types or otherwise enters one or more search parameters. These parameters preferably include one or more user preferences, for example with regard to the search terms, optionally describing a relation between them and/or with regard to how the search is to be performed, for example by providing a preference for web sites already viewed by the user and/or stored by the user (for example with regard to their URLs or other addresses) as being of particular interest. Stages 1 or 2 may optionally be performed in any order and/or may be repeated.

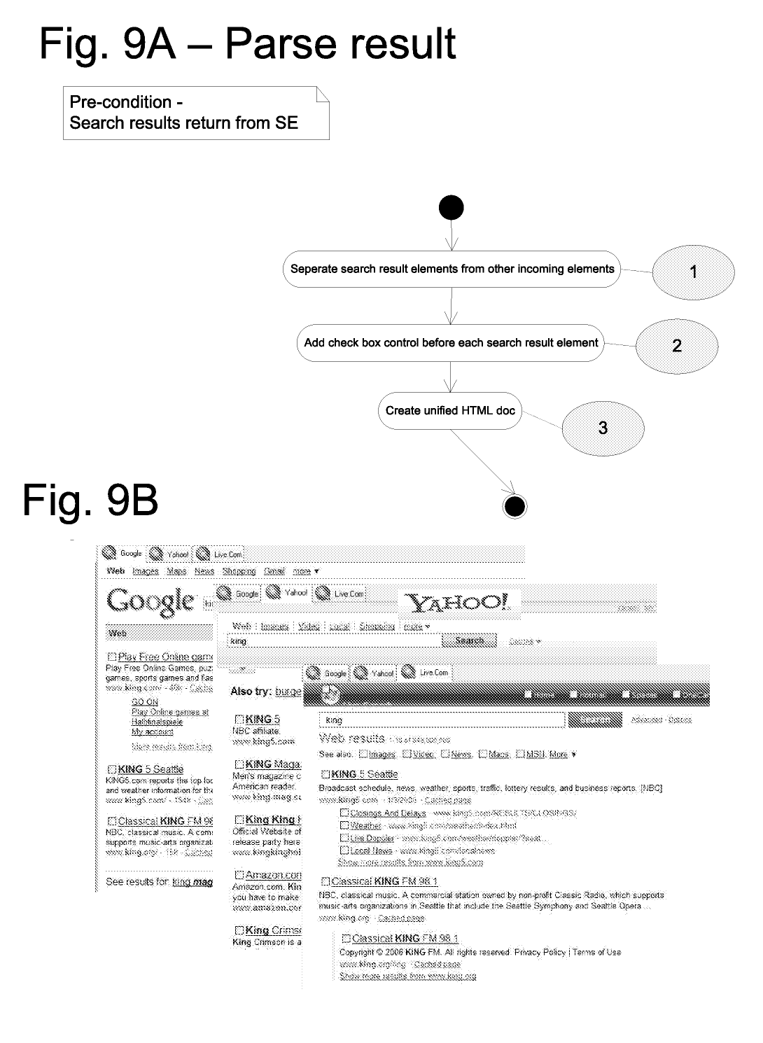

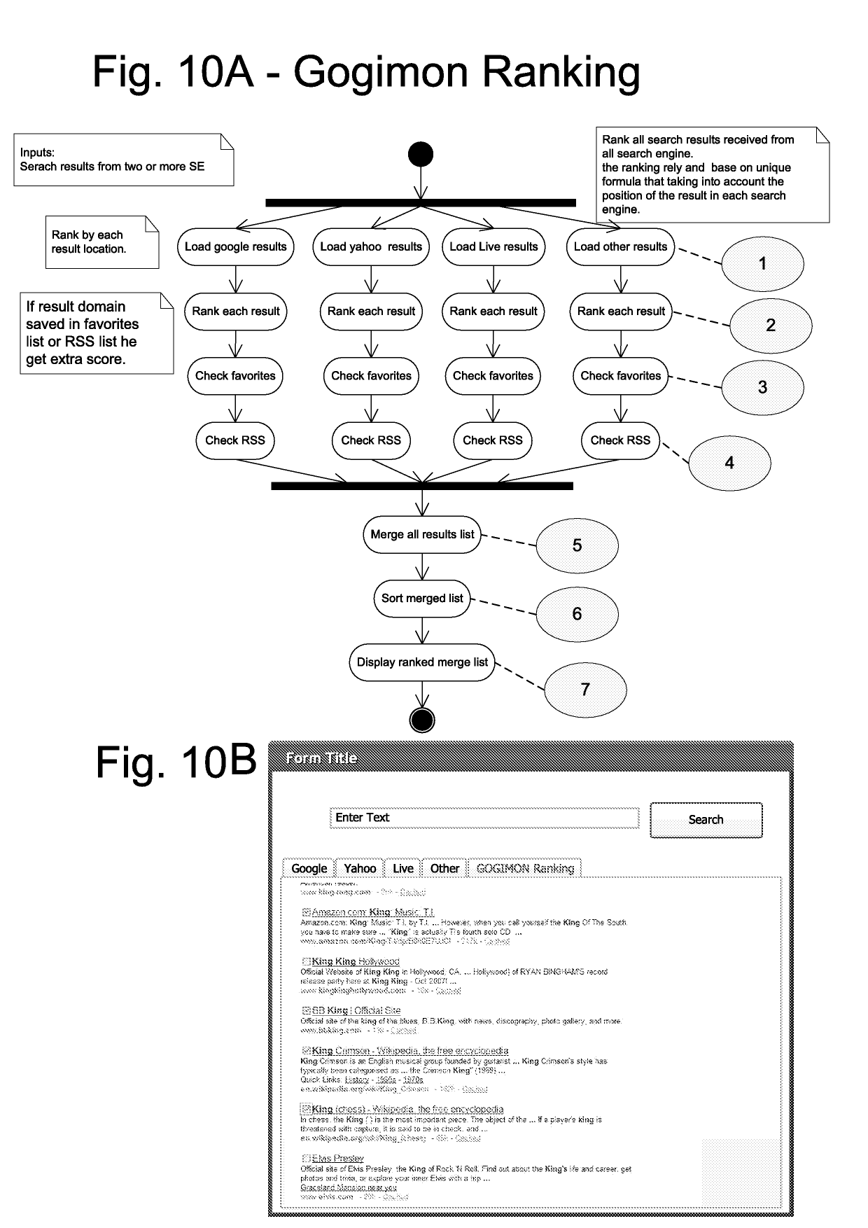

FIG. 9A shows a flowchart of an exemplary, illustrative method for parsing search results once they have been received after a search request. The method is described with regard to search results received from a plurality of search engines although optionally it could also be performed with regard to search results received from a specific search engine.

In stage 1, the search results from each search engine are optionally separated from other transmitted information, such as advertisements, “pop up” windows and non-result information. Alternatively, stage 1 is not performed.

In stage 2, a selectable control element is preferably provided next to each search result for display to the user, for permitting selection of one or more results by the user. If search results are provided from a plurality of search engines, preferably results from each search engine are shown separately.

In stage 3, a unified display is preferably created for showing all search results selected by the user through interaction with the selectable control element(s). The unified display may optionally comprise a unified mark-up language document, such as a unified HTML or XML document for example.

FIG. 9B shows three exemplary, non-limiting web page containers, with checkboxes at the left hand side for user selection.

FIG. 10A shows a flowchart of an exemplary, illustrative method according to the present invention for ranking results of a search. As shown, in stage 1, the results are received from one or more search engines. In stage 2, the results are preferably ranked according to their relative location within the results from each search engine and/or according to one or more qualification parameters with regard to each search engine itself (as set by user preferences and/or according to an automatic determination of the quality or qualities of each search engine; for example, the degree to which the most relevant results appear earlier in the search results).

In stage 3, optionally one or more user parameters are used to examine and rank the results, such as for example “favorites” or other saved and/or visited URLs or other addresses. In stage 4, optionally results are weighted according to whether they appear in an RSS list and/or other list for continuous searches and/or other searches according to a syndication protocol, to examine and weigh the results.

In stage 5, preferably results from a plurality of search engines are merged. In stage 6, the merged results are preferably sorted according to one or more (optionally weighted) parameters, including for example search engine popularity, rank within the different search engine listings and the like. In stage 7, the ranked, merged list is preferably displayed to the user.

FIG. 10B shows an exemplary Gogimon browser interface with the ranked, merged list of results shown under the heading “GOGIMON Ranking”.

FIG. 11 shows a flowchart of an exemplary, illustrative method according to the present invention for constructing RSS feeds from search results. For the purpose of description for FIG. 11, it should be noted that the term “RSS” may optionally refer to any syndication protocol. In stage 1, any previously obtained search results (for example from any of the previously described methods) are preferably converted to the RSS format. Such a conversion is well known in the art and could easily be performed by one of ordinary skill in the art. It should be noted that RSS is provided as an example only of a syndication protocol and is not meant to be limiting in any way. In stage 2, an exact query is preferably constructed from the search results, and is also preferably constructed from the search query itself, in the RSS format. Preferably the query and the results are parsed to obtain metadata, such as the title, headings, keywords, characterizing terms, metatags, date of the search (for the date of publication in RSS) and so forth. The metadata is then converted to the RSS format as is known in the art. In stage 3, an update search is preferably scheduled according to the exact query. In stage 4, the results of the update search are preferably added to the RSS list.

FIG. 12 shows an exemplary, illustrative method for a background web communication channel. As shown, in stage 1, information about one or more user activities is collected. Such activities may optionally include but are not limited to search terms used, frequency of use of such terms, frequency of viewing certain web site domains and/or categories, categories of information searched, module versions of an installed interface according to the present invention and so forth.

In stage 2, the user information is preferably anonymized (rendered anonymous) in a Gogimon ranking web page, to remove any personal details or other identifiers. In stage 3, the web page itself is preferably sent to the back channel server, to avoid inappropriate triggering of firewalls or other blocking software.

FIG. 13 shows an exemplary, illustrative collaborative search process and system 1300. The process preferably involves a Gogimon client 1302 and a Gogimon server 1304, as well as other components (not shown for the sake of simplicity; however their functions are described for the process).

Turning first to Gogimon client 1302, the process preferably involves performing a search, whether through a guided search 1306 or a search term input 1308 which is performed without directly guidance, as previously described. Optionally, the user may choose to perform a selective search 1310 as described in greater detail below, in which a pre-search process is optionally performed to prepare the search terms and/or structure for submission; alternatively the user may instead choose to directly submit the search 1312. The search term(s) and optional structure (if any) are then preferably sent 1314 to Gogimon server 1304.

At Gogimon server 1304, optionally an ad-hoc search community is created 1316 to assist with the particular search and/or with searches in general; in stage 1318, preferably the communication identifier(s) for the members of the ad-hoc community are sent to all Gogimon members, such as those users having Gogimon client 1302.

Turning back to Gogimon client 1302, at stage 1320 the user may optionally choose whether to perform a layered search 1322 as previously described, or whether to connect to the ad-hoc community 1324. For the latter, the user may optionally seek one or more recommendations from members of the ad-hoc community in stage 1326. For example, the users may participate through chats, IP telephony and/or other types of messaging in order to communicate such information.

For either type of search, in stage 1328, selective parallel download is optionally performed as previously described, at which point the user may optionally disconnect 1330 from the ad-hoc community.

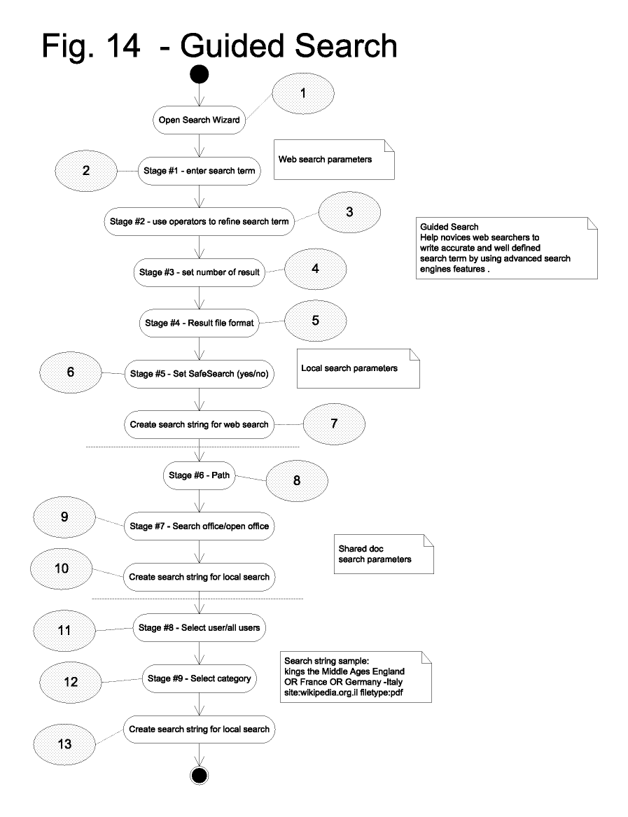

FIG. 14 shows a flowchart of an exemplary, illustrative method according to the present invention for performing a guided search. The guided search preferably assists the user in constructing search terms and performing searches. In stage 1, a search wizard interface is preferably displayed to the user for providing assistance. Such an interface may optionally be displayed in combination with or alternatively separately from the previously described user search interface. The user enters a search term to the search wizard interface.

In stage 2, the user preferably enters one or more search terms. In stage 3, one or more operators are preferably suggested to the user in order to refine the search term, including but not limited to one or more of terms for defining relationships between words such as “and”, “or”, “and not” and so forth.

In stage 4, optionally and preferably the user sets the total of number of desired results. In stage 5, preferably the user determines the file format for the results. In stage 6, the user may optionally set a “safe search” requirement. This requirement may optionally restrict the search to a particular set of domains and/or domain type (in which case it may optionally already have been set for the user by an external party, such as the parents of a child for example) and/or whether a certain type of domain and/or list of explicit domains should be excluded. In stage 7, the search parameters are preferably entered or created for a web search.

In stage 8, if the search is to include searching on a local computer as described previously, preferably one or more path parameters for such a search are provided. Optionally, for a local search, in stage 9 one or more additional search engines are invoked, for example that of Microsoft Office®. In stage 10, the search parameters are preferably entered or created for a local search. It should be noted that stages 8-10 are optional, as they may optionally be performed in place of, or alternatively in addition to, stages 5-7.

In stage 11, the user may optionally choose to set one or more parameters for a shared document search, by selecting one or more users and/or all users. In stage 12, the user preferably selects a category for searching, for example the result language and domain region and/or IP address region. Also optionally the user determines which domain types are permitted, for example only “dot com” and/or also domains for specific countries and so forth. In stage 13, the search parameters are preferably entered or created for a shared document search. Again stages 11-13 are optional, as they may optionally be performed in place of, or alternatively in addition to, stages 5-7 or 8-10.

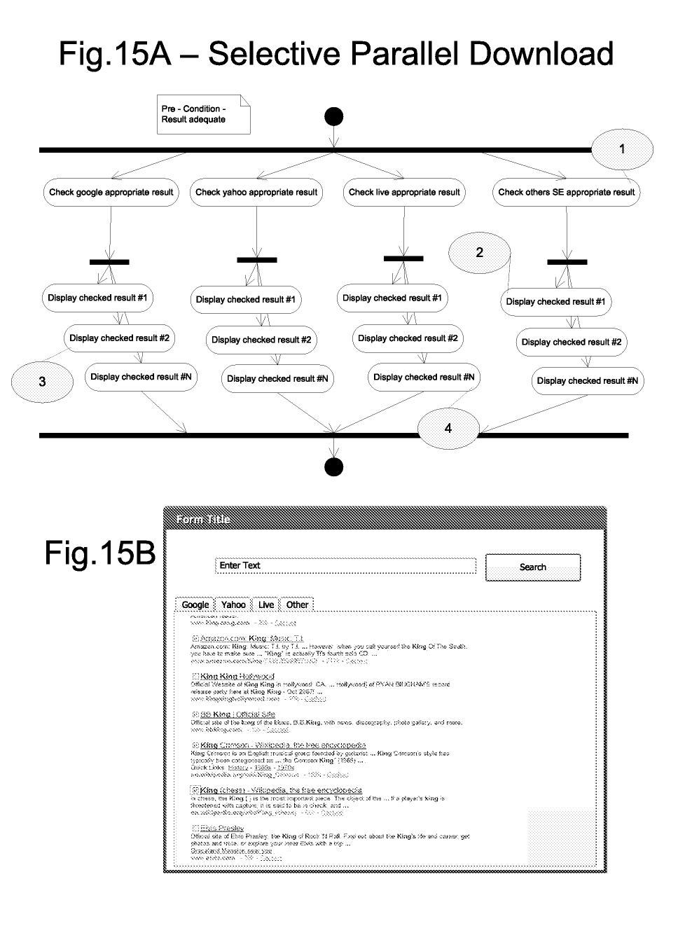

FIG. 15A shows a flowchart of an exemplary, illustrative method according to the present invention for selective parallel download of search results (ie obtaining and displaying search results). Once a search has been performed for a user, the user preferably determines whether the search results were adequate. If so, then in stage 1, the user preferably selects one or more results from the one or more searches performed with one or more search engines. This selection process may also optionally be performed on parsed and/or combined and/or re-ranked results as previously described in FIG. 10. In stage 2, all of the first ranked checked results are preferably displayed. In stage 3, all of the next ranked checked results are preferably displayed, which is preferably performed so forth until all checked results have been displayed (as signified by stage 4). Optionally with regard to the user experience, stages 2-4 are performed in parallel such that they preferably do not appear as separate stages to the user.

FIG. 15B shows an exemplary user interface display featuring such checked results being displayed.

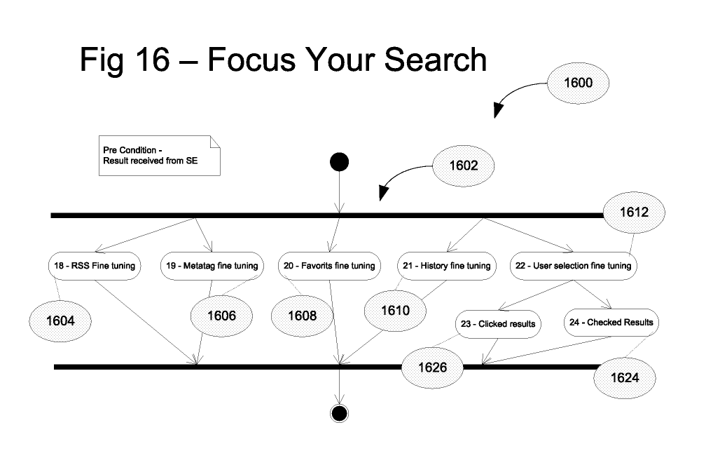

FIG. 16 shows a schematic block diagram of an exemplary, illustrative system according to the present invention for focusing a search of the user, preferably once the user has received at least initial search results. A system 1600 preferably features a plurality of fine tuning functional modules 1602 for assisting the user to “fine tune” or adjust the results, optionally including among them a RSS fine tuning module 1604 for adjusting the results according to a search through RSS feeds or documents. By “adjusting” it is meant preferably focusing or narrowing the results. Such adjustments preferably enable the user to have an expedited, more efficient search. Optionally the user may choose to limit the results for example to RSS feeds. Again, RSS is intended only as a non-limiting example of a syndication protocol.

System 1600 also preferably features a metatag fine tuning module 1606 for adjusting the search results according to one or more metatag terms, preferably as selected by the user. The metatag terms are preferably searched and obtained from within the web pages that were found as part of the initial search.

Various fine tuning modules also preferably operate with regard to one or more personal details of the user. For example, a favorites fine tuning module 1608 preferably selects those results which have a connection to the “favorites” or saved URLs (or other addresses), for example by being from the same domain. A history fine tuning module 1610 preferably relates to adjusting results according to one or more previously visited or viewed web pages, more preferably by URL but optionally by a combination of address and one or more metatags.

A user selection fine tuning module 1612 preferably allows the user to enter one or more parameters for adjusting the results. More preferably, user selection fine tuning module 1612 features a clicked results module 1624, which the user already visited and/or viewed, and a checked results module 1626, which are selected results. For both modules 1624 and 1626, the user preferably enters one or more additional search terms for searching within the previously visited and/or viewed (more preferably according to number of visits and/or views within a domain), and/or selected, search results.

FIG. 17 shows a flowchart of an exemplary, illustrative method according to the present invention for performing a continuous search. As shown, search results, and optionally also the search query, are loaded in a format which is preferably a syndication protocol format, such as RSS for example, in stage 1. In stage 2, updates are preferably scheduled according to how often they are performed. In stage 3, the update timer is preferably started. Once a predetermined period of time has elapsed, in stage 4 the CDRSS formatted results are parsed and the search string is obtained. In stage 5, a layered search is performed as previously described. Next, the results are preferably ranked in stage 6, for example according to Gogimon ranking. In stage 7, an RSS search is preferably initiated, for example according to the previously described CDRSS process. In stage 8, the results are displayed and saved, for example for off-line use and/or display. Optionally the process is repeated at least once. In stage 9, the process ends, optionally due to a user command.

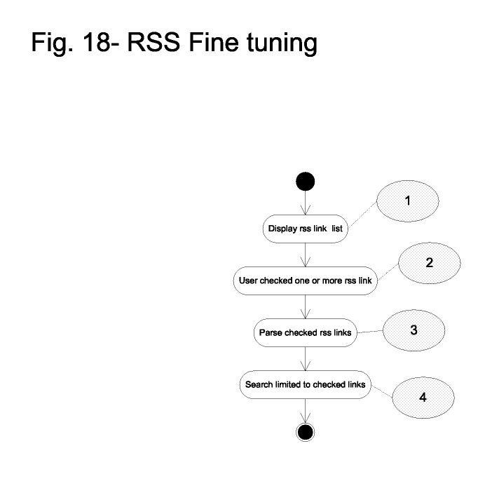

FIG. 18 shows a flowchart of an exemplary, illustrative method according to the present invention for performing RSS (or other syndication protocol) fine tuning of search results. Once the search results have been received, and preferably after the user has checked or otherwise selected a plurality of results, RSS fine tuning is preferably performed on the selected results. In stage 1, a RSS link list is preferably displayed, showing which links are related to RSS feeds. In stage 2, the user checks or otherwise selects one or more RSS feeds. In stage 3, the selected RSS feeds are preferably parsed to locate one or more domains or other URL or addressing information. In stage 4, such information is preferably used to build a domain list of relevant and important domains for further fine tuning of the results.

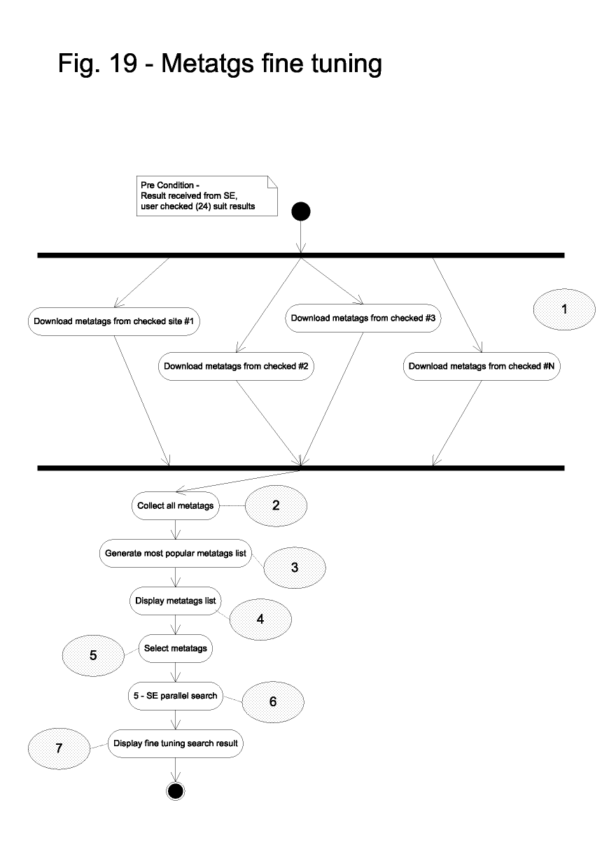

FIG. 19 shows a flowchart of an exemplary, illustrative method according to the present invention for performing fine tuning with metatags. Again the method is preferably performed once the search results have been received, and preferably after the user has checked or otherwise selected a plurality of results. In stage 1, preferably metatags are downloaded from the selected web sites and/or other results. In stage 2, the metatags are collected, preferably from the plurality of results. In stage 3, a list of the most popular and/or frequently used metatags is preferably generated, or at least a list of the metatags according to frequency. In stage 4, the metatags are displayed. In stage 5, one or more metatags are preferably selected by the user as being relevant for the specific query or search. In stage 6, a search is performed which optionally uses only the selected metatags but more preferably combines the selected metatags with one or more search terms previously determined by the user. In stage 7, the search results are displayed.

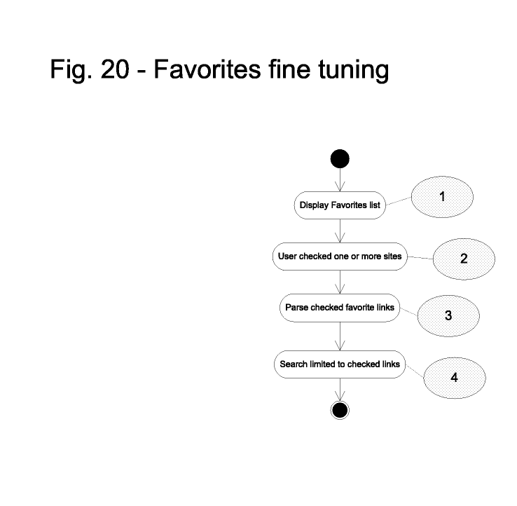

FIG. 20 shows a flowchart of an exemplary, illustrative method according to the present invention for performing fine tuning with favorites. Again the method is preferably performed once the search results have been received, and preferably after the user has checked or otherwise selected a plurality of results. In stage 1, the favorites (saved Internet domains and/or URLs and/or other addresses) are preferably displayed. In stage 2, the user preferably selects one or more addresses and/or Internet domains from the display according to which the results should be adjusted or fine tuned. In stage 3, the selected favorites are preferably parsed to obtain the desired domains or other URL or other addressing information. In stage 4, the search is preferably limited to the selected one or more domains or other URL or addressing information identifiers.

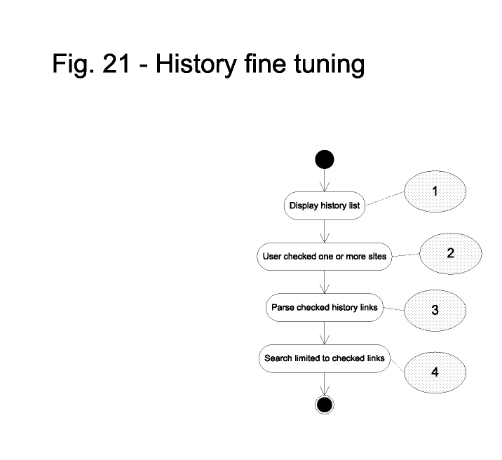

FIG. 21 shows a flowchart of an exemplary, illustrative method according to the present invention for performing fine tuning with previously viewed or displayed web pages and/or other results. Again the method is preferably performed once the search results have been received, and preferably after the user has checked or otherwise selected a plurality of results. In stage 1, the history list (regarding domains from previously viewed or displayed web pages and/or URLs and/or other addresses) is preferably displayed. In stage 2, the user preferably selects one or more domains and/or URLs and/or other addresses from the display according to which the results should be adjusted or fine tuned. In stage 3, the selected domains and/or URLs and/or other addresses are preferably parsed. In stage 4, the search is preferably limited to the selected one or more domains or other URL or addressing information identifiers.

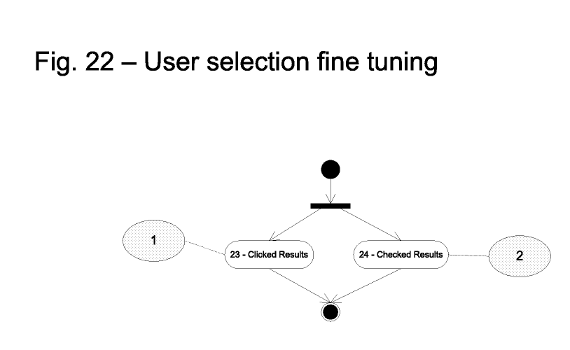

FIG. 22 shows an exemplary, illustrative method for fine tuning search results according to user selection. Prior to the performance of this method, the user has preferably performed a search but then decided to fine tune the results. In stage 1, the results are preferably fine tuned according to the amount of time the user interacts with one or more web domains and/or other previously viewed results, and/or the type of interactions as described in greater detail below. In stage 2, the results are preferably fine tuned according to one or more previously selected results, also as described in greater detail below. Optionally only one of the two stages is performed or they are performed in a different order or are performed repeatedly.

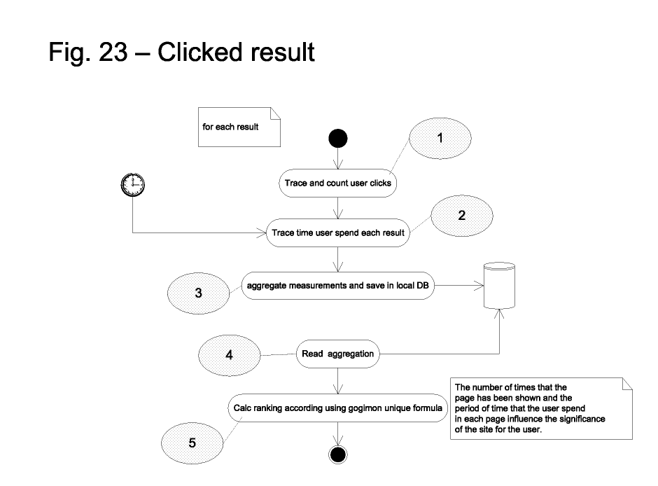

FIG. 23 shows an exemplary, illustrative method for fine tuning search results according to one or more previous user interactions. The method is preferably performed for each received result. In stage 1, the user “clicks” or interactions with one or more web pages and/or domains are preferably traced and counted. In stage 2, the amount of time the user spent interacting with each of the above web pages and/or domains is also preferably determined. In stage 3, the results of the measurements from stages 1 and 2 are preferably aggregated and are optionally saved locally (and/or on a remote site for later retrieval and use locally).

In stage 4, in order to perform the fine tuning, the measurements are preferably retrieved from the local or remote database. In stage 5, the ranking is preferably calculated for a particular search result according to these measurements.

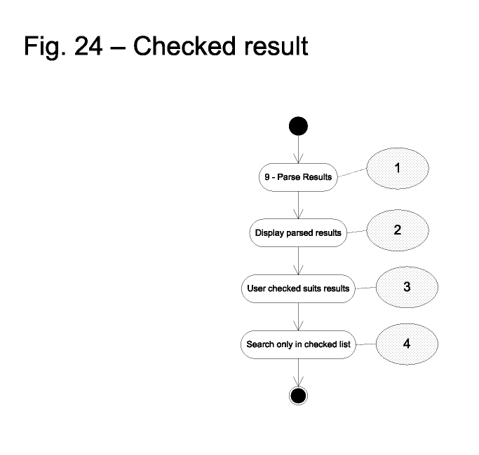

FIG. 24 shows an exemplary, illustrative method for fine tuning search results according to one or more checked previous user results. In stage 1, the results are preferably parsed. In stage 2, the parsed results are displayed. In stage 3, the user checks one or more results, after which the search is preferably performed again in stage 4.

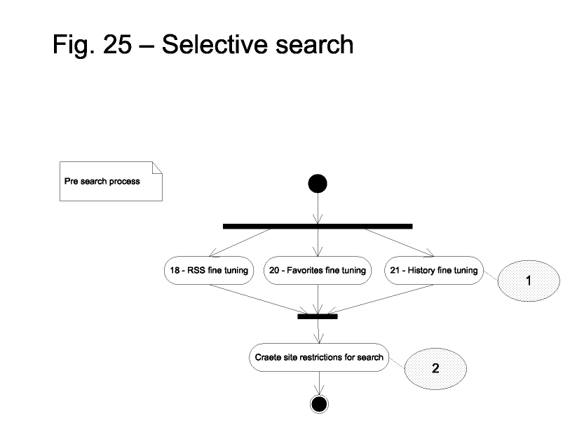

FIG. 25 shows an exemplary, illustrative method for fine tuning search results in a pre-search process. In stage 1, fine-tuning of the locations for searching is preferably performed according to one or more of RSS fine tuning, favorites fine tuning and/or history fine tuning, as previously described.

In stage 2, one or more restrictions of site locations are preferably determined for the search.

While the invention has been described with respect to a limited number of embodiments, it will be appreciated that many variations, modifications and other applications of the invention may be made.

What is claimed is:

1. A method for performing a structured search, comprising
Providing a dedicated user interface;
Entering one or more search terms to the user interface to perform a search;
Optimizing said search according to one or more of personalized user parameters, requested user parameters or detected user parameters;
Performing said search.

2. The method of claim 1, wherein said search is performed at one or more of at a local computer, through at least one web site or through at least one repository.

3. The method of claim 2, wherein said repository is not directly accessed through an HTTP server.

4. The method of claim 3, wherein said repository includes one or more of a mark-up language document, word processing document, audio, video, still images, executable files, or any other type of document format, or a combination thereof.

5. The method of claim 4, wherein each file in said repository comprises a description.

6. The method of claim 5, wherein said description comprises one or more of metatags, keywords or characterizing terms, or a combination thereof.

7. The method of claim 2, wherein local search comprises a search local to a computer of the user.

8. The method of claim 2, wherein said at least one web site comprises an internet search engine.

9. The method of claim 8, wherein said search is performed through a plurality of search engines.

10. The method of claim 1, wherein said detected user parameters include one or more of previously viewed web sites, previously viewed document repositories or documents or saved addresses.

11. The method of claim 1, wherein said requested user parameters include one or more of preferred language, number of results, or result location.

12. The method of claim 1, wherein said personalized user parameters include a guided search.

13. A client for a user computer, comprising:
A user interface for interacting with the user; and
At least one user assistive function for performing a search.

14. The client of claim 13, wherein said user assistive function comprises one or more of providing additional information and/or results and/or focusing and/or expedited results and/or optimization for a search.

15. The client of claim 14, further comprising an interface for communicating with a background web communication channel to an external server regarding at least one search function or result.

16. A method for performing an adaptive context search, comprising
Analyzing a first file being displayed to a user; and
Providing at least one identifier for another file related to said first file, wherein similarity is determined according to commonality between the file being viewed and one or more other files.

17. The method of claim 16, wherein each file is selected from the group consisting of mark-up language document, word processing document, audio, video, still images, executable files, or any other type of document format, or a combination thereof.

18. A method for performing a continuous search, comprising converting the search results to a syndicated protocol format;
and obtaining updated search results with said syndicated protocol format search results.

19. The method of claim 18, further comprising converting said search results according to one or more metatags.
